(19) United States
(12) Patent Application Publication
(10) Pub. No.: US 2024/0251983 A1
(43) Pub. Date: Aug. 1, 2024

(54) BEVERAGE MAKER WITH MOVABLE WATER FILL CHAMBER

(71) Applicant: Hamilton Beach Brands, Inc., Glen Allen, VA (US)

(72) Inventors: Mark K. Romandy, Glen Allen, VA (US); Mark C. Steiner, Glen Allen, VA (US); Patrick Walraven, Glen Allen, VA (US)

(21) Appl. No.: 18/102,481

(22) Filed: Jan. 27, 2023

(51) Int. Cl. A47J 31/44; A47J 31/057

(52) U.S. Cl. CPC A47J 31/44; A47J 31/057

(57) ABSTRACT

A beverage maker includes: a platform; a tower mounted to and extending upwardly from the platform; an arm fixed to and extending generally horizontally from the tower and over the platform, the arm including a brew basket; and a water fill chamber mounted to and positioned above the arm. The water fill chamber is movable relative to the arm between an operating position, in which the water fill chamber overlies the brew basket, and an access position, in which the water fill chamber is positioned away from the brew basket to allow a user access to the brew basket.

### FIELD OF THE INVENTION

The present invention relates generally to small appliances, and more specifically to beverage makers.

### BACKGROUND

Automatic drip coffeemakers are well known and widely used. They are effective to brew carafes of coffee, typically containing five to twelve cups or more of liquid. Automatic drip coffee makers may also be used for brewing small batches (one to four cups).

A typical automatic drip coffeemaker includes a brew basket that contains ground coffee (presented loosely in a bowl-shaped filter or within a “pod”-type package often referred to “K-Cups”). Heated water is conveyed to the brew basket and released, where it gravimetrically flows downwardly through the coffee grounds and into a receptacle such as a carafe or pot. Exemplary automatic drip coffeemakers are discussed in U.S. Pat. No. 5,001,969 to Moore et al.; U.S. Pat. No. 7,066,080 to Hsu; and U.S. Pat. No. 8,065,952 to Wang, the disclosures of which are hereby incorporated herein by reference in full. Some coffeemakers are designed to brew coffee in different forms; for example, coffeemakers offered in the FLEXBREW® line of products available from Hamilton Beach Brands (Richmond, Virginia) include an insert that enables the user to choose between a pod or loose ground coffee.

For convenience, some coffeemakers have a “front-loading” design, in which water for brewing is poured into a reservoir accessed from the front of the coffeemaker. This design can make supplying water more convenient by enabling the coffeemaker to be positioned on a counter below a cabinet; because the coffeemaker receives water in a basin located in the front portion of the upper arm of the coffeemaker, the user need not move the coffeemaker from its position on the counter. Such a design typically employs a brew basket that is positioned almost immediately beneath the aforementioned fill basin. The brew basket typically pivots about a vertical axis away from the fill basin to allow it to be filled with coffee and any necessary filter, and to allow spent coffee grounds and filters to be removed. While this is a relatively convenient arrangement, the spent grounds can be relatively heavy, particularly when wet, which can require that the hinge used to attach the brew basket to the housing of the coffeemaker be rather sturdy. Further, there are considerations for aligning the basket securely under the showerhead. It may be desirable to provide a design that addresses some of the shortcomings of prior designs.

### SUMMARY

As a first aspect, embodiments of the invention are directed to a beverage maker. The beverage maker comprises: a platform; a tower mounted to and extending upwardly from the platform; an arm fixed to and extending generally horizontally from the tower and over the platform, the arm including a brew basket; and a water fill chamber mounted to and positioned above the arm. The water fill chamber is movable relative to the arm between an operating position, in which the water fill chamber overlies the brew basket, and an access position, in which the water fill chamber is positioned away from the brew basket to allow a user access to the brew basket.

As a second aspect, embodiments of the invention are directed to a beverage maker comprising: a platform; a tower mounted to and extending upwardly from the platform; an arm fixed to and extending generally horizontally from the tower and over the platform, the arm including a brew basket; and a water fill chamber mounted to and positioned above the arm. The water fill chamber is rotatable relative to the arm between an operating position, in which the water fill chamber overlies the brew basket, and an access position, in which the water fill chamber is positioned away from the brew basket to allow a user access to the brew basket.

As a third aspect, embodiments of the invention are directed to a beverage maker comprising: a platform; a tower mounted to and extending upwardly from the platform, the tower including a reservoir; an arm fixed to and extending generally horizontally from the tower and over the platform, the arm including a brew basket; and a water fill chamber mounted to and positioned above the arm. The water fill chamber is rotatable relative to the arm between an operating position, in which the water fill chamber overlies the brew basket, and an access position, in which the water fill chamber is positioned away from the brew basket to allow a user access to the brew basket. The water fill chamber includes a filling compartment in fluid communication with the reservoir and a dispensing trough. The reservoir is in fluid communication with a fluid path that is routed between the reservoir and the dispensing trough of the water fill chamber. A heated water fill conduit is positioned between the heating element and the dispensing trough; the heated water fill conduit is substantially parallel with an axis of rotation for the water fill chamber.

### BRIEF DESCRIPTION OF THE FIGURES

FIG. 1 is a front perspective view of a beverage maker according to embodiments of the invention, wherein the water fill chamber is shown in its operating position.

FIG. 2 is an enlarged, partial front perspective view of the beverage maker of FIG. 1 with the door removed.

FIG. 3 is an enlarged, partial front perspective view of the beverage maker of FIG. 1 with the door and cover removed.

FIG. 4 is a partial side section view of the beverage maker of FIG. 1 showing the sloped floor of the water fill chamber.

FIG. 5 is a side section view of the beverage maker of FIG. 1.

FIG. 6 is a bottom perspective view of the beverage maker of FIG. 1 illustrating the fluid path and heating element.

FIG. 7 is a partial front perspective view of the beverage maker of FIG. 1 showing the water fill chamber in the operating position.

FIG. 8 is a rear partial perspective view of the water fill chamber and the heated water supply extension in the operating position.

FIG. 9A is a bottom perspective view of the floor of the water fill chamber of the beverage maker of FIG. 1.

FIG. 9B is a top perspective view of the floor of FIG. 9A.

FIG. 10 is a top perspective section view of the beverage maker of FIG. 1 with the water fill chamber in a rotated access position to provide access to the brew basket.

### DETAILED DESCRIPTION

The present invention is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

It will also be understood that, as used herein, the terms “example,” “exemplary,” and derivatives thereof are intended to refer to non-limiting examples and/or variants embodiments discussed herein, and are not intended to indicate preference for one or more embodiments discussed herein compared to one or more other embodiments.

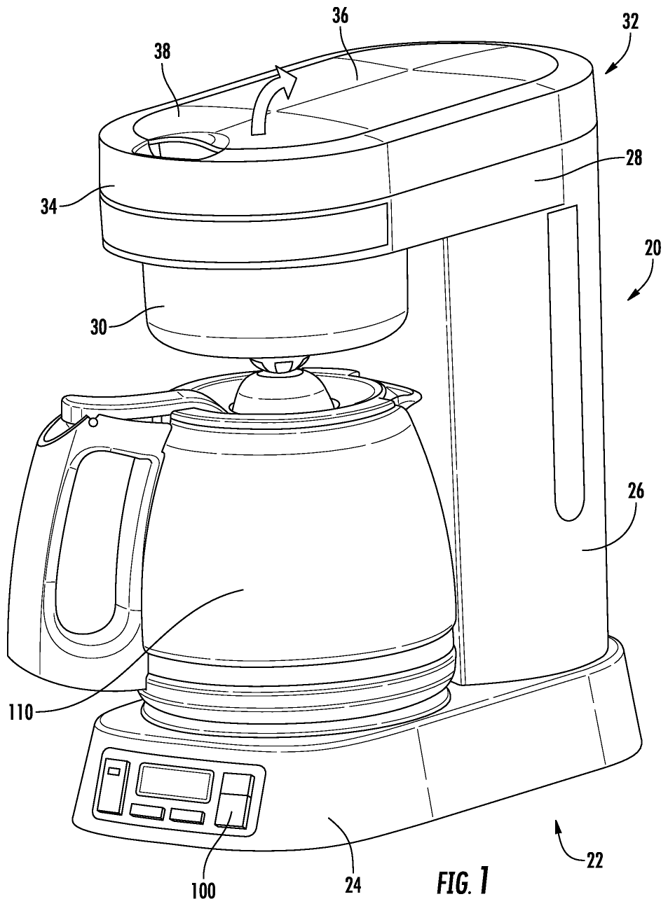

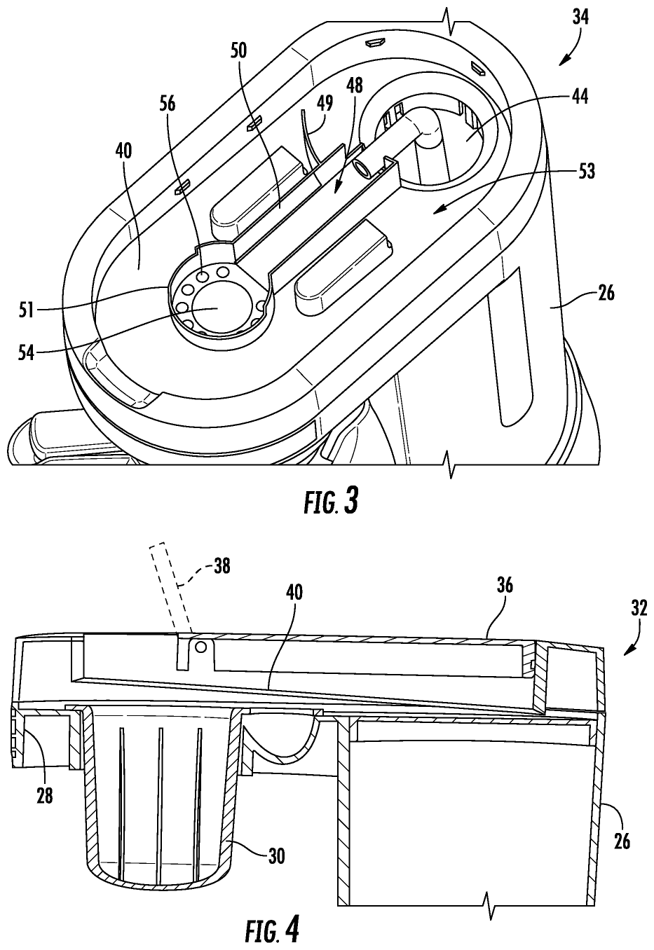

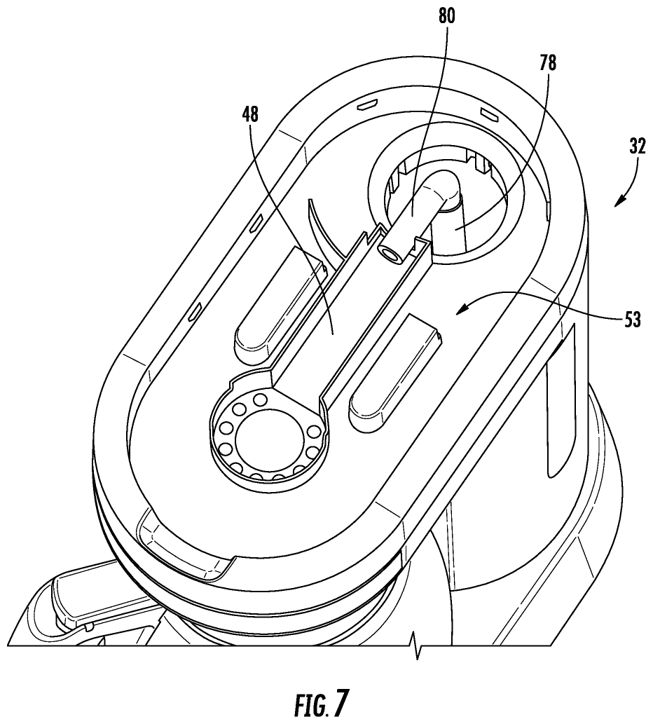

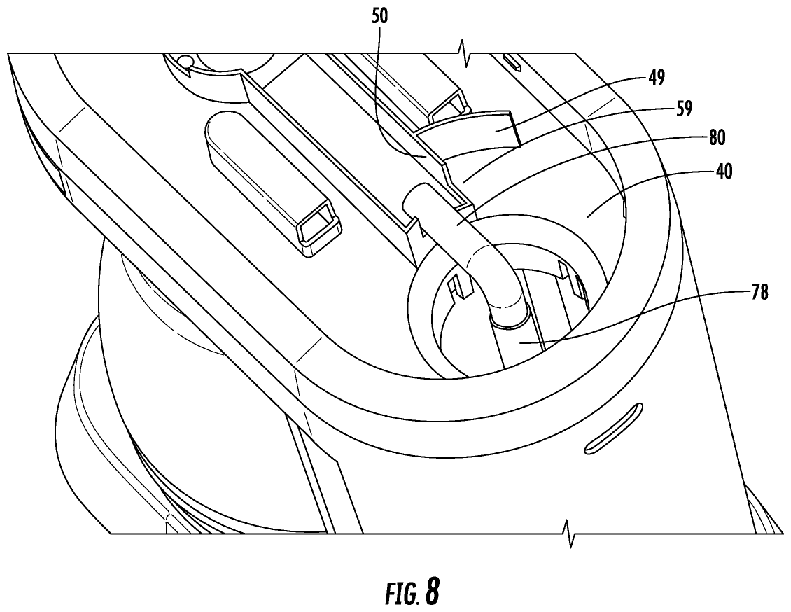

Referring now to the drawings, a beverage maker according to embodiments of the invention is illustrated in FIGS. 1-10 and designated broadly at 20. Generally, the beverage maker 20 includes an overall housing 22 that has a platform 24, a vertical tower 26 that rises from the rear end of the platform 24, and an arm 28 that extends forwardly from the upper end of the tower 26. A brew basket 30 is fixed to and depends downwardly from the arm 28. A water fill chamber 32 is pivotally mounted to the tower 26 above the arm 28 and is movable between an operating position (FIG. 1) and a fill position (FIG. 10).

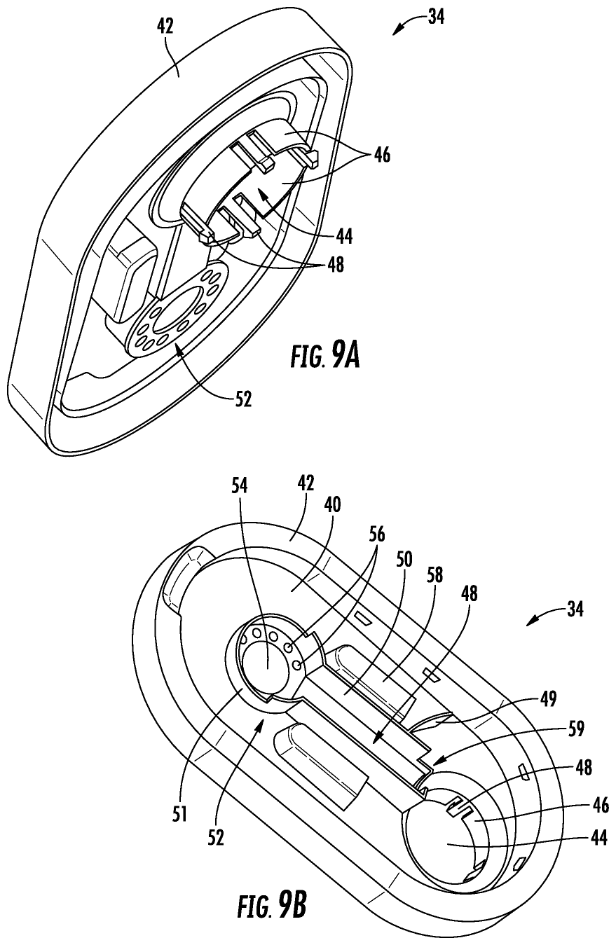

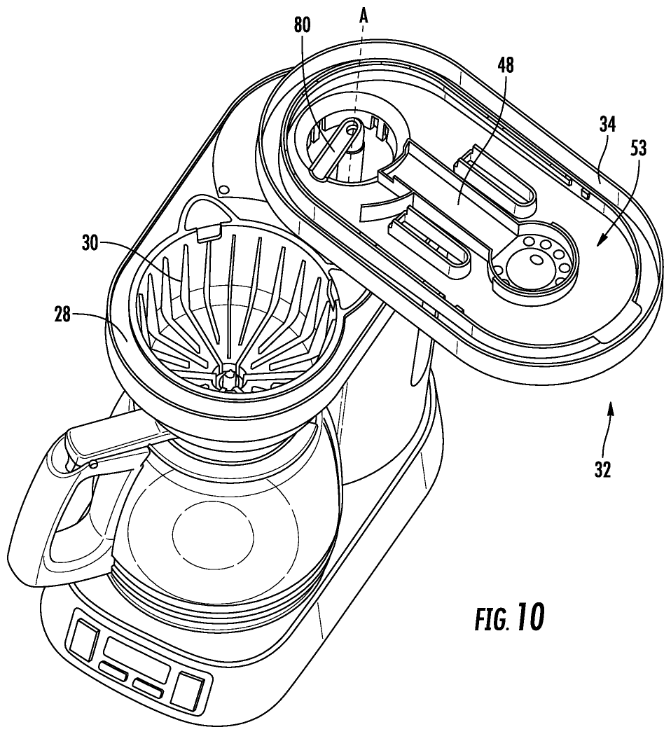

Referring now to FIGS. 1-3, 9A and 9B, the water fill chamber 32 includes a base 34, a cover 36 and a door 38. As can be seen in FIGS. 9A and 9B, the floor 34 has a sloped floor 40 surrounded by a double wall 42 that acts as a fence. A large drainage hole 44 is present in the rear portion of the floor 40. As can be seen in FIG. 9A, four curved panels 46 and four latches 48 (which alternate with the panels 46) extend downwardly from the floor 40 and surround the drainage hole 44. A dispensing trough 48 formed partially by walls 50 extends forwardly from the drainage hole 44 to a water dispensing outlet 52 that has a large central hole 54 and smaller holes 56 radially outward of the hole 54. A circular wall 51 connects the walls 50 and surrounds the holes 54, 56. Also, a venting chimney 58 for steam from the brewed beverage is located laterally of each side of the trough 50. A cutout 59 is present at the rear end of one of the walls 50 of the trough 48.

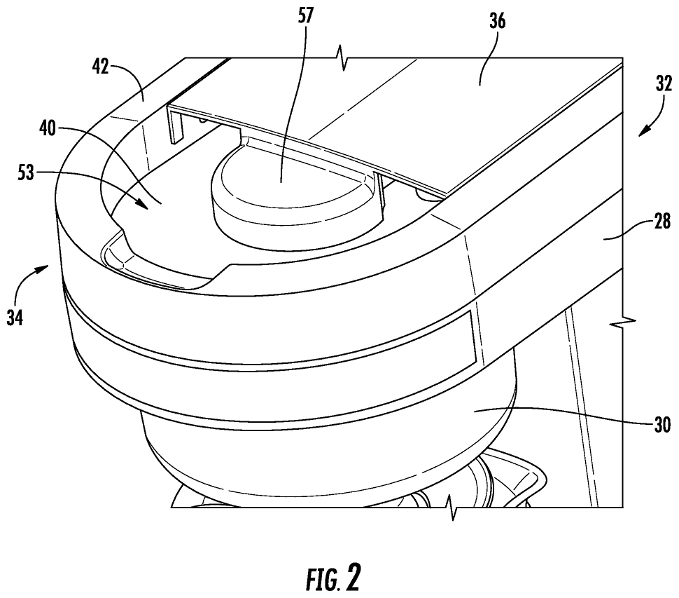

As shown in FIGS. 1 and 2, the cover 36 fits between and is fixed to the portions of the wall 42 in the middle and rear of the base 34. At its forward end, the cover 36 includes a hollow circular knob 57 that fits over the circular wall 51. Thus, the cover 36, the walls 50, 51 and the portion of the floor 40 surrounded by the walls 50, 51 define the dispensing trough 48. The remainder of the floor 40, the double wall 42, and the walls 50, 51 define a filling compartment 53.

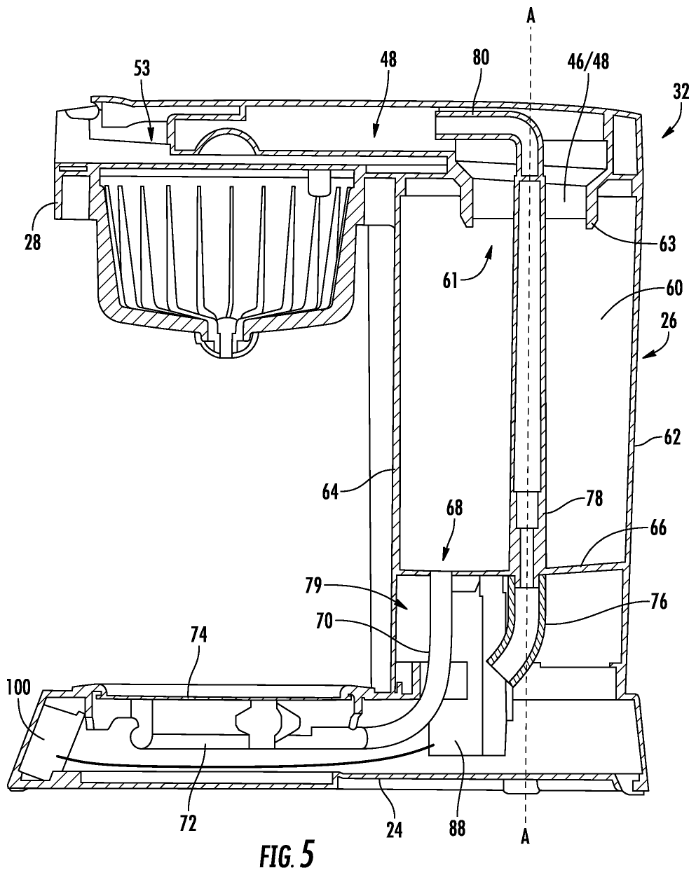

The door 38 is pivotally attached to the base 34 and can rotate such that its forward end rises and moves away from the front end of the base 34, thereby providing access to the interior of the water fill chamber 32 (see arrow in FIG. 1 and the door 38 shown in broken line in FIG. 4).

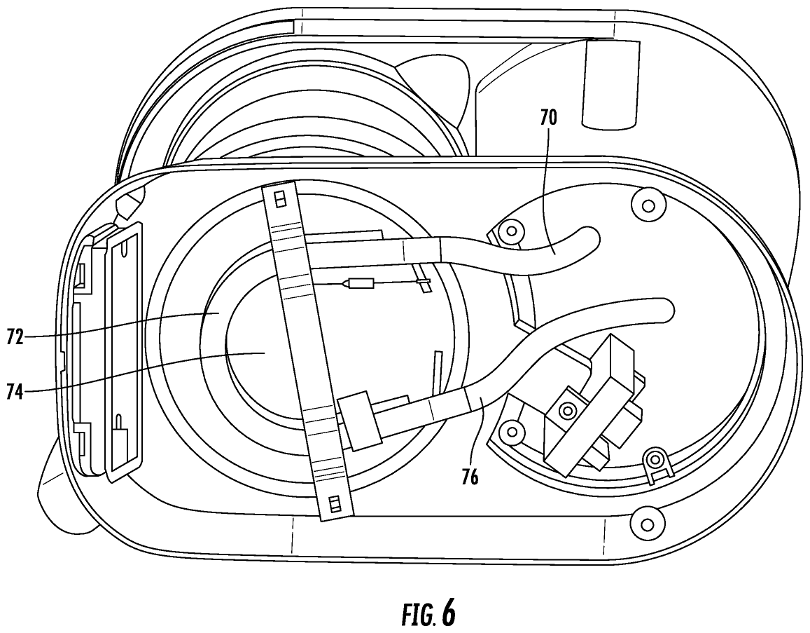

Referring now to FIGS. 5 and 6, many of the remaining components of the beverage maker 20 are shown therein. As shown in FIG. 5, much of the tower 26 is a reservoir 60, which is defined by walls 62 and 64, a floor 66, and the lower surface of the water fill chamber 32. The panels 46 and latches 48 of the base 34 of the water fill chamber are inserted into a large opening 61 in the top of the reservoir 60 that is encircled by a circular boss 63. The latches 48 engage the lower edge of the boss 63 to maintain the water fill chamber 32 in place. The interaction between the latches 48 and panels 46 with the boss 63 enables the water fill chamber 32 to rotate relative to the reservoir 60 (and, in turn, to the rest of the housing 22) about a vertical axis A that passes through the center of the opening 61.

Continuing to refer to FIGS. 5 and 6, an inlet 68 in the floor 66 feeds into a hose 70 that leads into one end of a “horseshoe”-shaped tubular heating element 72. The heating element 72 is mounted in the platform 24 below a warming plate 74. The opposite end of the heating element 72 feeds a hose 76 that leads to an inlet 76 of a heated water feed conduit 78. The heated water feed conduit 78 extends upwardly into the water fill chamber 32 (generally parallel to, and in this embodiment collinear with, axis A), then extends horizontally via an extension 80 into the rear end of the dispensing trough 48. Thus, a fluid path 79 is created between the reservoir 60 and the dispensing trough 48 (FIG. 5)

The beverage maker 20 does not include a pump for conveying water from the reservoir 60, through the hose 70, through the heating element 72, through the hose 76, and into and through the heated water feed conduit 78. Instead, the head pressure from the reservoir and the pressure generating by heating the water with the heating element 72 is sufficient to convey heated water through the heated water feed conduit and to the brew basket 30. However, in other embodiments the beverage maker 20 may include a pump to convey the water along the fluid path 79. A pump would be operatively connected with a controller 88 mounted within the housing 22 (see FIG. 5), which is also connected to a power cord (not shown) that can be used to provide power to the beverage maker 20. The heating element 72 is also connected to the controller 88.

The beverage maker 20 also includes a user input device (shown herein as a control panel 100 on the front of the platform 24) to enable a user to activate the beverage maker 20, select brew strength, and the like. The control panel 100 may be operatively connected to the controller 88 discussed above.

To operate the beverage maker, the user deposits matter to be brewed (e.g., coffee or tea) in the brew basket 30. Because the brew basket 30 is fixed relative to the remainder of the housing 22, it is only accessible for filling when the water fill chamber 32 is moved to the access position shown in FIG. 10. This is achieved by rotating the water fill chamber 32 about the axis A relative to the reservoir 60. This action moves the front end of the water fill chamber 32 away from the brew basket 30, such that the upper end of the brew basket 30 is open to the environment and can receive coffee, tea, etc. that is to be brewed.

The heated water feed conduit 78 is fixed relative to the water fill chamber 32. Thus, as shown in FIG. 10, in the access position the heated water feed conduit 78 does not rotate relative to the reservoir 60 when the water fill chamber 32 rotates to the access position. The extension 80 of the heated water feed conduit 78, which as described above extends into the dispensing trough 48 in the operating position of FIG. 1, does not interfere with the rotation of the water feed chamber 32 in the feed position because of the presence of the cutout 59 in one of the trough walls 50.

Once the brew matter has been deposited into the brew basket 30, the water fill chamber 32 can be rotated about the axis A back to the operating position of FIG. 1, wherein the water fill chamber 32 overlies the brew basket 30.

Water is added to the beverage maker 20 through the water fill chamber 32. To add water, the water fill chamber 32 is rotated to the operating position of FIG. 1. The door 38 is pivoted so that its front end rises, thereby providing access to the interior of the water fill chamber 32 (shown in broken line in FIG. 4). Water is added (typically by pouring) to the water fill chamber 32 through the access provided by the open door 38. Water entering the water fill chamber 32 is encouraged by the incline of the floor 40 toward and into the drainage hole 44. Water is kept out of the dispensing trough 48 by the walls 50, circular wall 51 and knob 57. Water flows through the drainage hole 44 and into the reservoir 60, where it resides until the beverage maker 20 is used to brew a beverage.

Those of skill in this art will recognize that brew matter may be added to the brew basket 30 either before or after water has been added to the reservoir 60 through the water fill chamber 32.

Once both the brew basket 30 is filled with brew matter and water is added to the water reservoir 60, the beverage maker 20 may be operated to brew a beverage. The user manipulates the control panel 100 to make selections regarding the beverage, then activates the beverage maker 20 begin brewing (e.g., by depressing a power button or switch on the control panel 100). Activation induces the controller 88 to supply power to the heating element 72 to begin heating. Water travels from the reservoir 60 into the hose 70, through the heating element 72, through the hose 76, and into the heated water feed conduit 78. Heated water is then directed by the extension 80 into the dispensing trough 48. The heated water travels within the dispensing trough 48 into the holes 56 (confined within the dispensing trough 48, and substantially fluidly isolated from the filling compartment 53, by the walls 50 and the circular wall 51), then into the brew basket 30. Once in the brew basket 30, the heated water seeps into and through the brew matter in the brew basket 30 to produce a brewed beverage. The brewed beverage exits the lower end of the brew basket 30 and fills a vessel, such as the pot 110 shown in FIG. 1.

It should be noted that, in the event that the water fill chamber 32 is or becomes rotated to the access position of FIG. 10 during the operation of the beverage maker 20, heated water exiting the extension 80 will flow onto the floor 40 of the base 34, from where it will travel back through the drainage hole 44 in the floor 40 and into the reservoir 60. In the illustrated embodiment, a deflector 49 extends from the wall 50 adjacent the cutout 59 to block water exiting the extension 80 when the water fill chamber 32 is rotated to the fill position. Thus, even if the beverage maker 20 is operated incorrectly, hot water does not escape the beverage maker 20 to pose a safety concern to the user.

It can be seen that the beverage maker 20 provides several desirable aspects. It has the capability of being filled from the front, which may be more convenient and save on counter space compared to other beverage makers. The beverage maker 20 provides this front-fill capability while also allowing the brew basket 30 to be accessed without being pivoted out of the way, thereby eliminating the need for a heavy-duty hinge for pivoting the brew basket 30.

Those of skill in this art will appreciate that the beverage maker 20 may take other forms. For example, the fluid path followed by the water during heating may vary. As noted above, a pump may be employed to convey water along the fluid path. A different variety of heating element may be employed. The dispensing trough 48 may take the form of a different type of dispensing compartment. Other variations in the basic operation of the beverage maker may also be suitable.

In addition, the manner in which the water fill chamber 32 pivots to provide access to the brew basket 30 may vary. For example, rather than pivoting on an axis that is substantially collinear with the axis of the heated water feed conduit 78, the pivot may be located further to the rear. Under such circumstances, it may be desirable for the heated water feed conduit to be relatively flexible, such that it can bend somewhat to accommodate the pivoting of the water fill chamber 32.

Further, in some embodiments, the water fill chamber 32 may provide access to the brew basket 30 via a different movement relative to the arm 28. As an example, rather than pivoting relative to the brew basket 30, the water fill chamber 32 may slide laterally (i.e., to the left or right of the brew basket 30) relative to the brew basket 30. As another example, the water fill chamber 32 may be configured so that the front portion of the floor 34 (which overlies the brew basket 30) slides rearwardly relative to the remainder of the floor 34 to provide access to the brew basket 30. Other variations may also be apparent to those of skill in this art.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A beverage maker, comprising:
a platform;
a tower mounted to and extending upwardly from the platform;
an arm fixed to and extending generally horizontally from the tower and over the platform, the arm including a brew basket; and
a water fill chamber mounted to and positioned above the arm, the water fill chamber being movable relative to the arm between an operating position, in which the water fill chamber overlies the brew basket, and an access position, in which the water fill chamber is positioned away from the brew basket to allow a user access to the brew basket.

2. The beverage maker defined in claim 1, wherein the water fill chamber includes a filling compartment and a dispensing compartment that is substantially fluidly isolated from the filling compartment, wherein the dispensing compartment is in fluid communication with the brew basket.

3. The beverage maker defined in claim 2, wherein the tower includes a reservoir, and wherein the filling compartment of the water fill chamber is in fluid communication with the reservoir.

4. The beverage maker defined in claim 3, wherein the reservoir is in fluid communication with a fluid path that is routed between the reservoir and the dispensing compartment of the water fill chamber.

5. The beverage maker defined in claim 4, wherein the fluid path is routed adjacent a heating element.

6. The beverage maker defined in claim 5, wherein a heated water fill conduit is positioned between the heating element and the dispensing compartment.

7. The beverage maker defined in claim 6, wherein the heated water fill conduit is routed through the reservoir.

8. The beverage maker defined in claim 2, wherein the dispensing compartment is a dispensing trough.

9. A beverage maker, comprising:
a platform;
a tower mounted to and extending upwardly from the platform;
an arm fixed to and extending generally horizontally from the tower and over the platform, the arm including a brew basket; and
a water fill chamber mounted to and positioned above the arm, the water fill chamber being rotatable relative to the arm between an operating position, in which the water fill chamber overlies the brew basket, and an access position, in which the water fill chamber is positioned away from the brew basket to allow a user access to the brew basket.

10. The beverage maker defined in claim 9, wherein the water fill chamber includes a filling compartment and a dispensing compartment that is substantially fluidly isolated from the filling compartment, wherein the dispensing compartment is in fluid communication with the brew basket.

11. The beverage maker defined in claim 10, wherein the tower includes a reservoir, and wherein the filling compartment of the water fill chamber is in fluid communication with the reservoir.

12. The beverage maker defined in claim 11, wherein the reservoir is in fluid communication with a fluid path that is routed between the reservoir and the dispensing trough of the water fill chamber.

13. The beverage maker defined in claim 12, wherein the fluid path is routed adjacent a heating element.

14. The beverage maker defined in claim 13, wherein a heated water fill conduit is positioned between the heating element and the dispensing trough.

15. The beverage maker defined in claim 14, wherein the heated water fill conduit is routed through the reservoir.

16. The beverage maker defined in claim 10, wherein the dispensing compartment is a dispensing trough.

17. A beverage maker, comprising:
a platform;
a tower mounted to and extending upwardly from the platform, the tower including a reservoir;
an arm fixed to and extending generally horizontally from the tower and over the platform, the arm including a brew basket; and
a water fill chamber mounted to and positioned above the arm, the water fill chamber being rotatable relative to the arm between an operating position, in which the water fill chamber overlies the brew basket, and an access position, in which the water fill chamber is positioned away from the brew basket to allow a user access to the brew basket;
wherein the water fill chamber includes a filling compartment in fluid communication with the reservoir and a dispensing trough;
wherein the reservoir is in fluid communication with a fluid path that is routed between the reservoir and the dispensing trough of the water fill chamber;
wherein a heated water fill conduit is positioned between the heating element and the dispensing trough, the heated water fill conduit being substantially parallel to an axis of rotation for the water fill chamber.

18. The beverage maker defined in claim 17, wherein the heated water fill conduit is fixed relative to the water fill chamber.

19. The beverage maker defined in claim 17, wherein the heated water fill conduit is routed through the reservoir.

20. The beverage maker defined in claim 18, wherein the dispensing trough is positioned within the water fill compartment.
